(19) United States
(12) Patent Application Publication
(10) Pub. No.: US 2024/0230945 A1
(43) Pub. Date: Jul. 11, 2024

(54) DETERMINATION DEVICE AND DETERMINATION METHOD

(71) Applicant: Panasonic Intellectual Property Management Co., Ltd., Osaka (JP)

(72) Inventors: Taro Imagawa, Osaka (JP); Akihiro Noda, Osaka (JP)

(21) Appl. No.: 18/618,281

(22) Filed: Mar. 27, 2024

Related U.S. Application Data
(63) Continuation of application No. PCT/JP2022/021133, filed on May 23, 2022.

(30) Foreign Application Priority Data
Oct. 4, 2021 (JP) 2021-163587

(51) Int. Cl. G01V 5/22; G06T 7/70; G06V 10/25

(52) U.S. Cl. CPC G01V 5/22; G06T 7/70; G06V 10/25

(57) ABSTRACT

A determination device includes: a distinctive region detector that detects a first distinctive region from first images that include a person and captured at mutually different time points; a reference position calculator that calculates a reference position from second images that include the person and captured at substantially the same time as the first images; a mapper that, when the first distinctive region is detected from one or more first images, maps, for each of the one or more first images, the detected first distinctive region onto the person included in a second image captured at substantially the same time as the first image, based on the first distinctive region and the reference position calculated from the second image; and a determiner that determines a possession of the person based on a mapping result. Each first image is a sub-terahertz wave image.

### CROSS REFERENCE TO RELATED APPLICATIONS

This is a continuation application of PCT International Application No. PCT/JP2022/021133 filed on May 23, 2022, designating the United States of America, which is based on and claims priority of Japanese Patent Application No. 2021-163587 filed on Oct. 4, 2021. The entire disclosures of the above-identified applications, including the specifications, drawings and claims are incorporated herein by reference in their entirety.

### FIELD

The present disclosure relates to a determination device that determines a person's possession.

### BACKGROUND

According to a known conventional technique, a terahertz wave image or a sub-terahertz wave image that includes a person is captured using terahertz waves or sub-terahertz waves, and the possession of the person is determined using the terahertz wave image or sub-terahertz wave image captured (see Patent Literature (PTL) 1, for example).

### CITATION LIST

### Patent Literature

PTL 1: Japanese Unexamined Patent Application Publication No. 2020-153973

### SUMMARY

### Technical Problem

The determination device that determines a person's possession using a sub-terahertz wave image that includes the person is required to determine the possession with relatively high accuracy.

In view of this, the present disclosure aims to provide a determination device etc. capable of determining a person's possession with relatively high accuracy by using a sub-terahertz wave image that includes the person.

### Solution to Problem

A determination device according to an aspect of the present disclosure is a determination device including: a distinctive region detector that detects a first distinctive region from each of a plurality of first images that include a person and have been captured at mutually different time points, the first distinctive region being a characteristic luminance distribution region; a reference position calculator that calculates a reference position regarding the person from each of a plurality of second images that include the person and have been captured at substantially a same time as the plurality of first images; a mapper that, when the distinctive region detector detects the first distinctive region from one or more first images included in the plurality of first images, maps, for each of the one or more first images, the first distinctive region detected from the first image onto the person included in one second image that is included in the plurality of second images and has been captured at substantially a same time as the first image, based on the first distinctive region and the reference position calculated by the reference position calculator from the one second image; a determiner that determines a possession of the person based on a mapping result of the mapper; and an outputter that outputs a determination result of the determiner, wherein each of the plurality of first images is a sub-terahertz wave image, and each of the plurality of second images is at least one of a visible light image, an infrared light image, or a distance image.

Note that sub-terahertz waves in the present specification mean electromagnetic waves of a frequency of at least 0.05 THz and at most 2 THz. The sub-terahertz waves in the present specification may be electromagnetic waves of a frequency of at least 0.08 THz and at most 1 THz. Also, in the present specification, “diffusely reflected” means that sub-terahertz waves incident on a reflector at macroscopically one incident angle are reflected at a plurality of reflection angles by a structure having an uneven surface with microscopic asperities.

A determination device according to an aspect of the present disclosure is a determination device including: an estimator that estimates, from a second image that includes a person, a virtual sub-terahertz wave image which would be captured at substantially a same time as the second image if sub-terahertz waves were emitted to the person; a distinctive region detector that detects a first distinctive region from a first image that includes the person and has been captured at substantially a same time as the second image, based on the virtual sub-terahertz wave image and the first image, the first distinctive region being a characteristic luminance distribution region; a determiner that determines a possession of the person based on the first distinctive region; and an outputter that outputs a determination result of the determiner, wherein the first image is a sub-terahertz wave image, and the second image is at least one of a visible light image, an infrared light image, or a distance image.

A determination method according to an aspect of the present disclosure is a determination method including: detecting a first distinctive region from each of a plurality of first images that include a person and have been captured at mutually different time points, the first distinctive region being a characteristic luminance distribution region; calculating a reference position regarding the person from each of a plurality of second images that include the person and have been captured at substantially a same time as the plurality of first images; when the first distinctive region is detected from one or more first images included in the plurality of first images in the detecting, mapping, for each of the one or more first images, the first distinctive region detected from the first image onto the person included in one second image that is included in the plurality of second images and has been captured at substantially a same time as the first image, based on the first distinctive region and the reference position calculated from the one second image in the calculating; determining a possession of the person based on a mapping result of the mapping; and outputting a determination result of the determining, wherein each of the plurality of first images is a sub-terahertz wave image, and each of the plurality of second images is at least one of a visible light image, an infrared light image, or a distance image.

A determination method according to an aspect of the present disclosure is a determination method including: estimating, from a second image that includes a person, a virtual sub-terahertz wave image which would be captured at substantially a same time as the second image if sub-terahertz waves were emitted to the person; detecting a first distinctive region from a first image that includes the person and has been captured at substantially a same time as the second image, based on the virtual sub-terahertz wave image and the first image, the first distinctive region being a characteristic luminance distribution region; determining a possession of the person based on the first distinctive region; and outputting a determination result of the determining, wherein the first image is a sub-terahertz wave image, and the second image is at least one of a visible light image, an infrared light image, or a distance image.

### Advantageous Effects

An aspect of the present disclosure provides a determination device etc. capable of determining a person's possession with relatively high accuracy by using a sub-terahertz wave image that includes the person.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an appearance of a determination system according to Embodiment 1.

FIG. 2 is a block diagram illustrating a configuration of the determination system according to Embodiment 1.

FIG. 3 is a schematic diagram illustrating a cross-sectional structure of a reflector according to Embodiment 1.

FIG. 4A is a schematic diagram illustrating an example of first light sources according to Embodiment 1 as viewed from the front.

FIG. 4B is a schematic diagram illustrating another example of the first light sources according to Embodiment 1 as viewed from the front.

FIG. 5 is a schematic diagram illustrating how a distinctive region detector according to Embodiment 1 detects a first distinctive region.

FIG. 6 is a schematic diagram illustrating an example of how a reference position calculator according to Embodiment 1 calculates the skeletal frame of a person as a reference position.

FIG. 7 is a schematic diagram illustrating an example of how a mapper according to Embodiment 1 maps first distinctive regions onto the person included in a second image.

FIG. 8 is a schematic diagram illustrating an example of an image displayed by an outputter according to Embodiment 1 on a display.

FIG. 9 is a flowchart of first determination processing.

FIG. 10 is a block diagram illustrating a configuration of a determination system according to Embodiment 2.

FIG. 11 is a schematic diagram illustrating an example of how a mapper according to Embodiment 2 maps first distinctive regions and a second distinctive region onto a person included in a second image.

FIG. 12 is a flowchart of second determination processing.

FIG. 13 is a block diagram illustrating a configuration of a determination system according to Embodiment 3.

FIG. 14 is a schematic diagram illustrating an example of how a reliability degree estimator according to Embodiment 3 estimates detection reliability degrees from a second image.

FIG. 15 is a schematic diagram illustrating examples of how a mapper according to Embodiment 3 maps a first distinctive region and detection reliability degrees onto a person included in a second image.

FIG. 16 is a flowchart of third determination processing.

FIG. 17 is a block diagram illustrating a configuration of a determination system according to Embodiment 4.

FIG. 18 is a schematic diagram illustrating an example of how an estimator according to Embodiment 4 estimates a virtual sub-terahertz wave image from a second image.

FIG. 19 is a schematic diagram illustrating an example of how a distinctive region detector according to Embodiment 4 detects a first distinctive region based on a virtual sub-terahertz wave image and a first image.

FIG. 20 is a flowchart of fourth determination processing.

FIG. 21 is a block diagram illustrating a configuration of a determination system according to Embodiment 5.

FIG. 22 is a flowchart of fifth determination processing.

### DESCRIPTION OF EMBODIMENTS

### Circumstances Leading to an Aspect of the Present Disclosure

Sub-terahertz waves pass through clothing, bags, and so on, and are specularly reflected by human bodies and metals, for example. Therefore, depending on the orientation of the camera capturing a sub-terahertz wave image, an image based on sub-terahertz waves reflected by a person's possession may not be clearly shown in the sub-terahertz wave image captured by the camera.

In order to determine a person's possession with relatively high accuracy, PTL 1 discloses a technique of capturing sub-terahertz wave images from various angles using a plurality of cameras that capture sub-terahertz wave images and determining a person's possession based on the plurality of sub-terahertz wave images captured from various angles.

In contrast, the inventors have conceived that if it is possible to provide a determination device capable of determining a person's possession with relatively high accuracy without a plurality of cameras that capture sub-terahertz wave images, it would be possible to determine a person's possession with relatively high accuracy by using a system having a relatively simple configuration.

In view of this, the inventors have intensively conducted much examination and experimentation on a determination device capable of determining a person's possession with relatively high accuracy without a plurality of cameras that capture sub-terahertz wave images.

Through examination and experimentation, the inventors have found that, since a person's possession faces in various directions as the person moves, even if only one camera is provided to capture sub-terahertz wave images, it is possible to capture images that are based on sub-terahertz waves reflected by the possession facing different directions, by capturing, at mutually different time points, a plurality of sub-terahertz wave images including, for example, the person walking.

The inventors have also found that when a sub-terahertz wave image includes a distinctive region that is a characteristic luminance distribution region attributable to a possession, it is possible to identify the position where the person has the possession (e.g., below an armpit under clothing, in a bag, etc.) by mapping the distinctive region onto the person included in a visible light image that has been captured at substantially the same time as the sub-terahertz wave image.

The inventors have also found that it is possible to determine the person's possession with relatively high accuracy by: estimating, from the visible light image that includes the person, has been captured at substantially the same time as the sub-terahertz wave image, and does not show the person's possession due to the possession being concealed by clothing, a bag, or the like, a virtual sub-terahertz wave image which would be captured at the time of capturing the visible light image; and comparing the estimated virtual sub-terahertz wave image with a sub-terahertz wave image that has been actually captured.

On the basis of these findings, the inventors have conducted further examination and experimentation, and have arrived at a determination device and a determination method according to an aspect of the present disclosure described below.

A determination device according to an aspect of the present disclosure is a determination device including: a distinctive region detector that detects a first distinctive region from each of a plurality of first images that include a person and have been captured at mutually different time points, the first distinctive region being a characteristic luminance distribution region; a reference position calculator that calculates a reference position regarding the person from each of a plurality of second images that include the person and have been captured at substantially the same time as the plurality of first images; a mapper that, when the distinctive region detector detects the first distinctive region from one or more first images included in the plurality of first images, maps, for each of the one or more first images, the first distinctive region detected from the first image onto the person included in one second image that is included in the plurality of second images and has been captured at substantially the same time as the first image, based on the first distinctive region and the reference position calculated by the reference position calculator from the one second image; a determiner that determines a possession of the person based on a mapping result of the mapper; and an outputter that outputs a determination result of the determiner, wherein each of the plurality of first images is a sub-terahertz wave image, and each of the plurality of second images is at least one of a visible light image, an infrared light image, or a distance image.

In general, a person's possession faces in various directions as the person moves. Therefore, first images, which are a plurality of sub-terahertz wave images, show images that are based on sub-terahertz waves reflected by the possession facing in various directions.

According to the determination device having the above-described configuration, when a first image, which is a sub-terahertz wave image, includes a distinctive region that is a characteristic luminance distribution region attributable to the possession, the distinctive region is mapped onto the person included in a second image that is at least one of a visible light image, an infrared light image, or a distance image and has been captured at substantially the same time as the first image. The possession is then determined based on the mapping result. That is to say, even when the person's possession moves along with movement of the person, the person's possession can be determined based on a relative positional relationship between the person and the possession.

Thus, the determination device having the above-described configuration can determine the person's possession with relatively high accuracy by using a sub-terahertz wave image that includes the person.

In addition, the determiner may determine the possession of the person based on a first determination condition regarding, among the one or more first images, mapping images in each of which the mapper has mapped the first distinctive region onto substantially the same position on the person.

With this, the possession can be determined based on the mapping images.

In addition, the first determination condition may be a determination condition regarding a total number of times mapping has been performed onto substantially the same position on each of the mapping images.

With this, the possession can be determined based on the total number of times mapping has been performed onto substantially the same position on each of the mapping images.

In addition, the first determination condition may be a determination condition regarding (i) a representative luminance representing the first distinctive region in each of the mapping images or (ii) a detection reliability degree of the first distinctive region in each of the mapping images.

With this, the possession can be determined based on (i) the representative luminance of the first distinctive region mapped in each of the mapping images or (ii) the detection reliability degree of the first distinctive region mapped in each of the mapping images.

In addition, the determiner may determine the possession of the person based on the first determination condition according to a position of the first distinctive region mapped in each of the mapping images.

With this, the possession can be determined based on the position of the first distinctive region mapped.

In addition, the determiner may further determine a type of the possession based on a shape of the first distinctive region mapped in each of the mapping images.

With this, the type of the possession can be determined.

In addition, the distinctive region detector may detect, as the first distinctive region, a region having a luminance higher than a first threshold or a region having a luminance lower than a second threshold that is lower than the first threshold.

This makes it possible to detect, as the first distinctive region, a region having a luminance higher than a first threshold or a region having a luminance lower than the first threshold.

In addition, the determination device may further include a reliability degree estimator that estimates, from each of the plurality of second images, a detection reliability degree indicating a reliability degree of detection from one first image that is included in the plurality of first images and has been captured at substantially the same time as the second image, and the mapper may also map the detection reliability degree onto the person included in the one second image, further based on the detection reliability degree estimated by the reliability degree estimator from the one second image.

The determination device having the above-described configuration determines the possession further based on the detection reliability degree.

Thus, the determination device having the above-described configuration can determine the possession with higher accuracy.

In addition, the distinctive region detector may attempt to further detect a second distinctive region from each of a plurality of third images that include the person and have been captured at substantially the same time as the plurality of second images, the second distinctive region being a characteristic luminance distribution region, when the distinctive region detector detects the second distinctive region from one or more third images included in the plurality of third images, the mapper may further map, for each of the one or more third images, the second distinctive region detected from the third image onto the person included in one second image that is included in the plurality of second images and has been captured at substantially the same time as the third image, based on the second distinctive region and the reference position calculated by the reference position calculator from the one second image, and each of the plurality of third images may be a sub-terahertz wave image.

The determination device having the above-described configuration determines the possession further based on the third images in addition to the first images and the second images.

Thus, the determination device having the above-described configuration can determine the possession with higher accuracy.

A determination device according to an aspect of the present disclosure is a determination device including: an estimator that estimates, from a second image that includes a person, a virtual sub-terahertz wave image which would be captured at substantially the same time as the second image if sub-terahertz waves were emitted to the person; a distinctive region detector that detects a first distinctive region from a first image that includes the person and has been captured at substantially the same time as the second image, based on the virtual sub-terahertz wave image and the first image, the first distinctive region being a characteristic luminance distribution region; a determiner that determines a possession of the person based on the first distinctive region; and an outputter that outputs a determination result of the determiner, wherein the first image is a sub-terahertz wave image, and the second image is at least one of a visible light image, an infrared light image, or a distance image.

The determination device having the above-described configuration estimates a virtual sub-terahertz wave image from a second image. Specifically, from a second image that: does not show the possession of the person due to the possession being concealed by clothing, a bag, or the like; has been captured at substantially the same time as a first image which is a sub-terahertz wave image; and is at least one of a visible light image, an infrared light image, or a distance image that includes the person, the determination device estimates a virtual sub-terahertz wave image which would be captured at the time of capturing the second image. The possession is then determined based on the estimated virtual sub-terahertz wave image and the first image which is a sub-terahertz wave image that has been actually captured.

Thus, the determination device having the above-described configuration can determine the person's possession with relatively high accuracy by using a sub-terahertz wave image that includes the person.

A determination method according to an aspect of the present disclosure is a determination method including: detecting a first distinctive region from each of a plurality of first images that include a person and have been captured at mutually different time points, the first distinctive region being a characteristic luminance distribution region; calculating a reference position regarding the person from each of a plurality of second images that include the person and have been captured at substantially the same time as the plurality of first images; when the first distinctive region is detected from one or more first images included in the plurality of first images in the detecting, mapping, for each of the one or more first images, the first distinctive region detected from the first image onto the person included in one second image that is included in the plurality of second images and has been captured at substantially the same time as the first image, based on the first distinctive region and the reference position calculated from the one second image in the calculating; determining a possession of the person based on a mapping result of the mapping; and outputting a determination result of the determining, wherein each of the plurality of first images is a sub-terahertz wave image, and each of the plurality of second images is at least one of a visible light image, an infrared light image, or a distance image.

In general, a person's possession faces in various directions as the person moves. Therefore, first images, which are a plurality of sub-terahertz wave images, show images that are based on sub-terahertz waves reflected by the possession facing in various directions.

According to the above-described determination method, when a first image, which is a sub-terahertz wave image, includes a distinctive region that is a characteristic luminance distribution region attributable to the possession, the distinctive region is mapped onto the person included in a second image that is at least one of a visible light image, an infrared light image, or a distance image and has been captured at substantially the same time as the first image. The possession is then determined based on the mapping result. That is to say, even when the person's possession moves along with movement of the person, the person's possession can be determined based on a relative positional relationship between the person and the possession.

Thus, the above-described determination method can determine the person's possession with relatively high accuracy by using a sub-terahertz wave image that includes the person.

A determination method according to an aspect of the present disclosure is a determination method including: estimating, from a second image that includes a person, a virtual sub-terahertz wave image which would be captured at substantially the same time as the second image if sub-terahertz waves were emitted to the person; detecting a first distinctive region from a first image that includes the person and has been captured at substantially the same time as the second image, based on the virtual sub-terahertz wave image and the first image, the first distinctive region being a characteristic luminance distribution region; determining a possession of the person based on the first distinctive region; and outputting a determination result of the determining, wherein the first image is a sub-terahertz wave image, and the second image is at least one of a visible light image, an infrared light image, or a distance image.

The above-described determination method estimates a virtual sub-terahertz wave image from a second image. Specifically, from a second image that: does not show the possession of the person due to the possession being concealed by clothing, a bag, or the like; has been captured at substantially the same time as a first image which is a sub-terahertz wave image; and is at least one of a visible light image, an infrared light image, or a distance image that includes the person, the determination method estimates a virtual sub-terahertz wave image which would be captured at the time of capturing the second image. The possession is then determined based on the estimated virtual sub-terahertz wave image and the first image which is a sub-terahertz wave image that has been actually captured.

Thus, the above-described determination method can determine the person's possession with relatively high accuracy by using a sub-terahertz wave image that includes the person.

Hereinafter, embodiments will be specifically described with reference to the drawings.

Note that each of the embodiments described below shows a general or specific example. The numerical values, shapes, materials, constituent elements, the arrangement and connection of the constituent elements, steps, the processing order of the steps etc. shown in the following embodiments are mere examples, and do not intend to limit the present disclosure.

In the present specification, terms indicating a relationship between elements such as “parallel”, terms indicating the shapes of elements such as “flat plate”, terms indicating time such as “immediately after”, and numerical value ranges do not express their strict meanings only, but also include substantially equivalent ranges, e.g., differences of several percent.

The drawings are not necessarily precise illustrations. Constituent elements that are substantially the same are given the same reference signs in the drawings, and redundant descriptions will be omitted or simplified.

### Embodiment 1

The following describes a determination system that captures sub-terahertz wave images and determines a person's possession based on the sub-terahertz wave images captured.

### [Configuration]

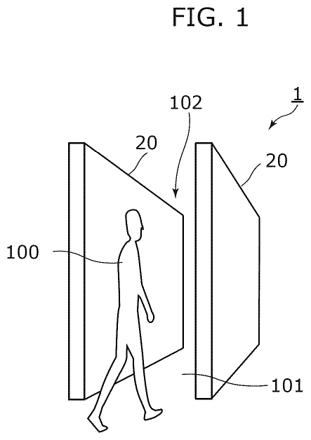

FIG. 1 is a schematic diagram illustrating an appearance of determination system 1 according to Embodiment 1. In FIG. 1, illustration of constituent elements other than reflectors 20 is omitted.

As illustrated in FIG. 1, determination system 1 emits sub-terahertz waves to person 100 when, for example, person 100 passes through imaging space 102 above pathway 101 interposed between reflectors 20, and determination system 1 captures sub-terahertz wave images based on reflected sub-terahertz waves that are sub-terahertz waves emitted by determination system 1 and reflected by person 100. A possession of person 100 is then determined based on the sub-terahertz wave images captured.

Imaging space 102 is, of the space above pathway 101, a space covered by reflectors 20. Determination system 1 determines a possession of person 100 such as a knife, a container with a flammable, etc. concealed by person 100 under clothing or in a bag, for example.

Hereinafter, the details of a configuration of determination system 1 will be described with reference to the drawings.

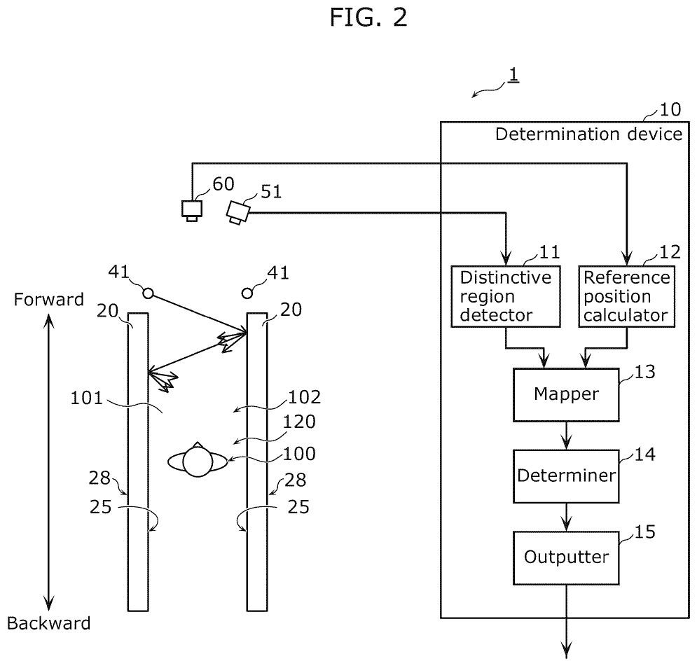

FIG. 2 is a block diagram illustrating a configuration of determination system 1.

FIG. 2 illustrates person 100 passing through imaging space 102. FIG. 2 also illustrates, with arrows, an example of the courses of travel of sub-terahertz waves emitted from first light sources 41.

Determination system 1 includes reflectors 20, first light sources 41, camera 51, camera 60, and determination device 10.

Reflectors 20 cover the space above pathway 101 that person 100 passes through, specifically imaging space 102, from at least one of both sides of pathway 101. Specifically, covering the space from at least one of both sides of pathway 101 means covering the space from at least one of both side directions that are two directions perpendicular to the extending direction of pathway 101 when pathway 101 is viewed from above. In Embodiment 1, imaging space 102 above pathway 101 that person 100 passes through is interposed between reflectors 20 from both sides of pathway 101. That is to say, reflectors 20 cover imaging space 102 from both sides of pathway 101. Imaging space 102 is, of the space above pathway 101, a space interposed between the inner surfaces (inner surfaces 25 to be described later) of reflectors 20, for example. In Embodiment 1, paired reflectors 20 stand on the floor surface on both sides of pathway 101 to face each other. In other words, paired reflectors 20, i.e., two reflectors 20, are disposed to have pathway 101 interposed therebetween in a top view. In the illustrated example, paired reflectors 20 are disposed to be parallel to each other. In the illustrated example, paired reflectors 20 each stand perpendicularly to the floor surface on which pathway 101 is provided. The heights of reflectors 20 from pathway 101 to the upper ends of reflectors 20 are at least 1.5 m and at most 5.0 m, for example, but are not particularly limited. The shapes of reflectors 20 as viewed in the extending direction of pathway 101 are two I-shapes in the case of paired reflectors 20, but are not particularly limited. It suffices so long as reflectors 20 are disposed on at least one of both sides of imaging space 102, and the shape of each reflector 20 as viewed in the extending direction of pathway 101 may be an I-shape, J-shape, L-shape, U-shape, C-shape, frame shape, or circular shape, for example. For example, determination system 1 may further include a reflector other than paired reflectors 20, or may include one reflector formed by extending and connecting the end portions of paired reflectors 20. Note that it suffices so long as determination system 1 includes at least one reflector 20. For example, determination system 1 may include only one of paired reflectors 20.

Each of paired reflectors 20 is in a plate shape. Each of paired reflectors 20 includes inner surface 25 and outer surface 28 each serving as the front surface when reflector 20 is viewed in the thickness direction of reflector 20. Paired reflectors 20 are disposed such that inner surface 25 of one of paired reflectors 20 and inner surface 25 of the other of paired reflectors 20 face each other. In other words, inner surface 25 is the surface of reflector 20 on the side where imaging space 102 is located. For example, each of paired reflectors 20 is in a flat plate shape having inner surface 25 and outer surface 28 parallel to inner surface 25. That is to say, the thickness of reflector 20 is uniform. The shape of each of paired reflectors 20 in a plan view is rectangular, for example, but is not particularly limited.

Reflectors 20 diffusely reflect sub-terahertz waves. Specifically, reflectors 20 diffusely reflect sub-terahertz waves incident from at least the imaging space 102 side (i.e., from the inner sides of paired reflectors 20). As illustrated in FIG. 2, the sub-terahertz waves emitted from first light source 41 are diffusely reflected one or more times by at least one of paired reflectors 20, and person 100 is irradiated with the diffusely-reflected sub-terahertz waves. As described, since imaging space 102 is interposed between reflectors 20 that diffusely reflect the sub-terahertz waves, the sub-terahertz waves that have entered imaging space 102 are likely to remain in imaging space 102, and person 100 is irradiated with the sub-terahertz waves from various angles.

Furthermore, since reflectors 20 are in a flat plate shape, it is possible to make determination system 1 thinner and smaller as compared to the case where a member such as a spherical mirror that concentrates sub-terahertz waves onto person 100 is used for reflecting sub-terahertz waves.

Next, a detailed configuration of reflectors 20 will be described.

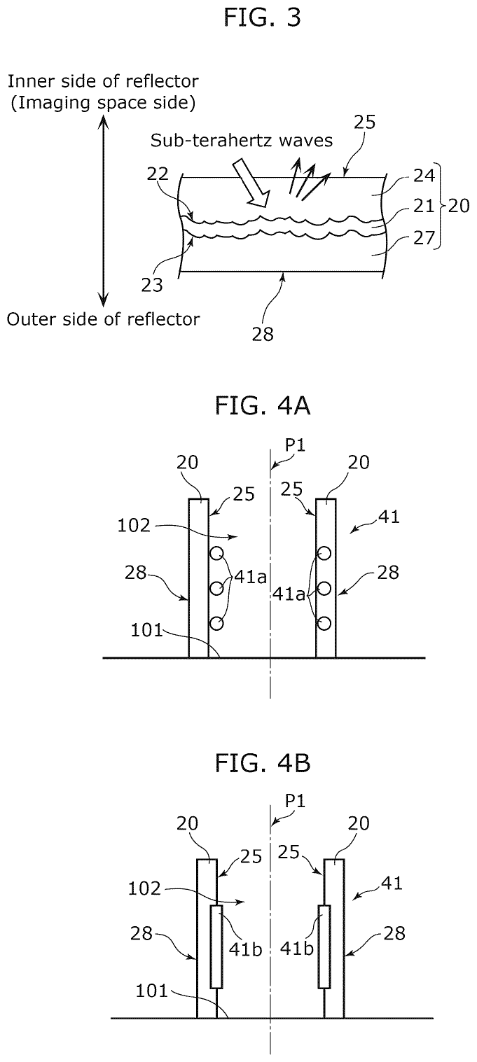

FIG. 3 is a schematic diagram illustrating a cross-sectional structure of reflector 20. FIG. 3 is an enlarged view of part of a cross section of reflector 20. Note that FIG. 3 omits diagonal hatching representing a cross section for better viewability.

Reflector 20 includes reflective member 21 and two cover members 24 and 27. Reflector 20 has a structure in which cover member 24, reflective member 21, and cover member 27 are stacked in the stated order from the imaging space 102 side.

Reflective member 21 is a member in a sheet shape, and diffusely reflects sub-terahertz waves. Reflective member 21 is located between cover members 24 and 27. Reflective member 21 includes two main surfaces 22 and 23 each serving as the front surface when reflective member 21 is viewed in the thickness direction of reflective member 21. Main surfaces 22 and 23 are uneven surfaces that diffusely reflect sub-terahertz waves. Main surface 22 is located on the imaging space 102 side of reflective member 21, and main surface 23 is located on a side of reflective member 21 opposite the imaging space 102 side. Two main surfaces 22 and 23 of reflective member 21 are covered by cover members 24 and 27 respectively. Specifically, main surface 22 located on the imaging space 102 side of reflective member 21 is covered by cover member 24, and main surface 23 located on the side of reflective member 21 opposite the imaging space 102 side is covered by cover member 27. Thus, main surfaces 22 and 23 do not constitute the surfaces of reflector 20 and are not exposed. With this, if main surfaces 22 and 23, which are uneven surfaces, are exposed, the uneven surfaces may come into contact with person 100; however, since main surfaces 22 and 23 are covered by cover members 24 and 27, respectively, reflective member 21 is protected.

For example, the average length of roughness curve element RSm of main surfaces 22 and 23, which are uneven surfaces, is greater than or equal to the wavelength of sub-terahertz waves emitted from first light sources 41. Specifically, the average length of roughness curve element RSm of main surfaces 22 and 23 may be at least 0.15 mm and at most 0.3 mm, for example. With this, the sub-terahertz waves are diffusely reflected by main surfaces 22 and 23 in an efficient manner. In the example illustrated in FIG. 3, the asperities of main surface 22 and the asperities of main surface 23 are the same in shape. Note that the asperities of main surface 22 and the asperities of main surface 23 may be different in shape. It suffices so long as main surface 22 of reflective member 21 on the imaging space 102 side is an uneven surface; main surface 23 may be a flat surface.

Reflective member 21 includes a metal or a conductive member such as a conductive oxide. Examples of the metal include a pure metal (single metal) and an alloy including at least one metal such as copper, aluminum, nickel, iron, stainless steel, silver, gold, or platinum. Examples of the conductive oxide include transparent conductive oxides such as ITO (indium tin oxide), IZO (InZnO: indium zinc oxide), AZO (AlZnO: aluminum zinc oxide), FTO (florine-doped tin oxide), SnO₂, TiO₂, and ZnO₂.

Cover members 24 and 27 each transmit sub-terahertz waves. Cover members 24 and 27 each transmit, for example, 50% or more of sub-terahertz waves entering in the thickness direction of reflector 20. Cover members 24 and 27 may each transmit 80% or more, or 90% or more, of sub-terahertz waves entering in the thickness direction of reflector 20.

Cover member 24 is located on the imaging space 102 side of reflective member 21 and covers main surface 22. The surface of cover member 24 located on a side of cover member 24 opposite the reflective member 21 side forms inner surface 25 of reflector 20. Unlike main surface 22, inner surface 25 is a flat surface without asperities. With this, even if person 100 passing through pathway 101 collides with inner surface 25 of reflector 20, person 100 is prevented from colliding with the uneven surface (i.e., main surface 22) of reflective member 21, thus protecting person 100 and main surface 22. In addition, since inner surface 25 of reflector 20 is a flat surface, it is easy to clean reflector 20.

Cover member 27 is located on a side of reflective member 21 opposite the imaging space 102 side and covers main surface 23. The surface of cover member 27 located on a side of cover member 27 opposite the reflective member 21 side forms outer surface 28 of reflector 20. Unlike main surface 23, outer surface 28 is a flat surface without asperities. This makes it easy to clean reflector 20.

It suffices so long as the material of cover members 24 and 27 is a material that allows cover members 24 and 27 to have and maintain their shapes. For example, a resin material is used as the material of cover members 24 and 27. For example, the resin material may be a transparent amorphous resin material that transmits visible light or may be a crystalline resin material that diffusely reflects visible light.

As illustrated in FIG. 3, with the above-described configuration, sub-terahertz waves entering from the inner side (i.e., the imaging space 102 side) of paired reflectors 20 enter cover member 24, diffusely reflect off main surface 22 of reflective member 21, and exit from inner surface 25 to the imaging space 102 side at various angles.

Paired reflectors 20 have the same configuration and include the same material, for example. Note that paired reflectors 20 may be different in at least one of configuration or material.

Referring back to FIG. 2 again, we continue with the description of determination system 1.

First light sources 41 are light sources that emit sub-terahertz waves to reflectors 20. Specifically, first light sources 41 emit sub-terahertz waves to inner surface 25 of at least one of paired reflectors 20. In addition, as illustrated in FIG. 2, first light sources 41 emit sub-terahertz waves to reflectors 20 so that part of the sub-terahertz waves emitted by first light sources 41 is diffusely reflected by reflectors 20 a plurality of times. Part of the sub-terahertz waves emitted by first light sources 41 may be incident on person 100 directly.

First light sources 41 may constantly emit sub-terahertz waves or may intermittently emit sub-terahertz waves in synchronization with the imaging performed by camera 51.

First light sources 41 are supported by, for example, a support member not illustrated in the drawings. First light sources 41 are each implemented by, for example, a publicly-known sub-terahertz wave generating element and a circuit that supplies current to the sub-terahertz wave generating element.

First light sources 41 are located forward of the center of imaging space 102 in the extending direction of pathway 101. The center of imaging space 102 is the center of a space formed by being interposed between reflectors 20. In the example illustrated in FIG. 2, first light sources 41 are located forward of reflectors 20 in the extending direction of pathway 101. First light sources 41 emit sub-terahertz waves to inner surfaces 25 of reflectors 20 from positions forward of reflectors 20.

First light sources 41 are located in the vicinity of forward end portions of paired reflectors 20.

Note that first light sources 41 may be located in imaging space 102, for example.

First light sources 41 include, for example, point light sources that emit sub-terahertz waves. FIG. 4A is a schematic diagram illustrating an example of first light sources 41 as viewed from the front. FIG. 4A omits illustration of constituent elements other than first light sources 41 and reflectors 20. As illustrated in FIG. 4A, first light sources 41 include a plurality of point light sources 41a that emit sub-terahertz waves and are arranged along reflectors 20 as viewed in the extending direction of pathway 101. In Embodiment 1, the plurality of point light sources 41a are arranged in the standing direction of paired reflectors 20. In FIG. 4A, three point light sources 41a are arranged along the forward end portion of one of paired reflectors 20, and another three point light sources 41a are arranged along the forward end portion of the other of paired reflectors 20. In other words, first light sources 41 include sets of a plurality of point light sources 41a arranged in the standing direction of paired reflectors 20. A total number of point light sources 41a arranged is not particularly limited, and may be two, four, or greater than four. In the example illustrated in FIG. 4A, the sets of a plurality of point light sources 41a are disposed symmetrically with respect to virtual plane P1. Virtual plane P1 is a vertical plane passing through the center of imaging space 102 and extending in the extending direction of pathway 101. Note that the plurality of point light sources 41a may be disposed only on one of paired reflectors 20.

First light sources 41 may include other light sources instead of the plurality of point light sources 41a. FIG. 4B is a schematic diagram illustrating another example of first light sources 41 as viewed from the front. FIG. 4B omits illustration of constituent elements other than first light sources 41 and reflectors 20. As illustrated in FIG. 4B, first light sources 41 include line light sources 41b that emit sub-terahertz waves and extend along reflectors 20 as viewed in the extending direction of pathway 101. In Embodiment 1, line light sources 41b extend in the standing direction of paired reflectors 20. In FIG. 4B, one line light source 41b is disposed extending along the forward end portion of one of paired reflectors 20, and another line light source 41b is disposed extending along the forward end portion of the other of paired reflectors 20. In other words, first light sources 41 include a pair of line light sources 41b. A total number of line light sources 41b disposed extending along the forward end portions of paired reflectors 20 may be two, or greater than two. In the example illustrated in FIG. 4B, paired line light sources 41b are disposed symmetrically with respect to virtual plane P1. Note that line light sources 41b may be one line light source 41b disposed only on one of paired reflectors 20.

As described above, first light sources 41 include at least (i) a plurality of point light sources 41a each of which emits sub-terahertz waves and which are arranged along reflectors 20 as viewed in the extending direction of pathway 101 or (ii) line light sources 41b which emit sub-terahertz waves and extend along reflectors 20 as viewed in the extending direction of pathway 101. With this, first light sources 41 can widely emit sub-terahertz waves along reflectors 20 as viewed in the extending direction of pathway 101. As a result, person 100 is irradiated with sub-terahertz waves efficiently.

Referring back to FIG. 2 again, we continue with the description of determination system 1.

Camera 51 captures a first image that includes person 100 and is a sub-terahertz wave image by receiving sub-terahertz waves emitted from first light sources 41, then diffusely reflected by reflectors 20, and reflected by person 100.

Camera 51 captures video. Thus, camera 51 captures a plurality of first images at mutually different time points. Camera 51 then outputs the plurality of first images captured to determination device 10. Camera 51 captures first images at 60 frames per second (FPS), for example.

Sub-terahertz waves pass through clothing, bags, and so on, and are specularly reflected by human bodies and metals, for example. Therefore, camera 51 receives sub-terahertz waves specularly reflected by a part of the body of person 100 in a region within an angle range in which camera 51 can receive sub-terahertz waves. When person 100 conceals a possession such as a knife, a container with a flammable, etc. under clothing or in a bag, for example, camera 51 receives sub-terahertz waves specularly reflected by a part of the concealed possession in the region within the angle range in which camera 51 can receive sub-terahertz waves.

When person 100 moves through pathway 101, person 100 and the possession of person 100 face in various directions. Thus, by capturing a plurality of first images at mutually different time points, camera 51 can capture images based on sub-terahertz waves reflected by person 100 and the possession of person 100 facing in different directions.

Camera 51 is located forward of the center of imaging space 102 in the extending direction of pathway 101. Camera 51 is supported by, for example, a support member not illustrated in the drawings.

Camera 60 captures a second image that includes person 100 and is at least one of a visible light image, an infrared light image, or a distance image by receiving visible and/or infrared light reflected by person 100. In Embodiment 1, the second image will be described as a visible light image.

Camera 60 captures video. Thus, camera 60 captures a plurality of second images at mutually different time points. Camera 60 then outputs the plurality of second images captured to determination device 10.

Camera 60 captures second images in synchronization with the imaging performed by camera 51. More specifically, camera 60 captures the second images at substantially the same time as when camera 51 captures the first images. Therefore, the plurality of second images captured by camera 60 are images captured at substantially the same time as the first images captured by camera 51. When camera 51 captures the first images at 60 FPS, for example, camera 60 captures the second images at the same frames per second as that of camera 51, that is, 60 FPS.

Determination device 10 determines the possession of person 100 by using sub-terahertz wave images that include person 100. More specifically, determination device 10 receives inputs of the plurality of first images output from camera 51 and the plurality of second images output from camera 60, determines the possession of person 100 based on the plurality of first images and the plurality of second images, and outputs the determination result.

In a computer device including, for example, a processor, memory, and an input and output interface, determination device 10 is implemented by the processor executing a program stored in the memory.

As illustrated in FIG. 2, determination device 10 includes distinctive region detector 11, reference position calculator 12, mapper 13, determiner 14, and outputter 15.

Distinctive region detector 11 attempts to detect a first distinctive region that is a characteristic luminance distribution region, from each of the plurality of first images that include person 100 and have been captured at mutually different time points by camera 51.

Distinctive region detector 11 may detect, as the first distinctive region, a region having, for example, luminance values significantly higher or significantly lower than luminance values of peripheral pixels.

Alternatively, distinctive region detector 11 may detect, as the first distinctive region, a region having a luminance higher than a first threshold or a region having a luminance lower than a second threshold that is lower than the first threshold, for example.

Alternatively, distinctive region detector 11 may detect, as the first distinctive region, a region having luminance values significantly higher or significantly lower than pixel values of pixels corresponding to an exposed part of person 100 (e.g., the face or hands), for example. Alternatively, distinctive region detector 11 may output a detection reliability degree for each region detected. For example, the degree of difference from a predetermined luminance value or output of what has been detected through machine learning may be used as the detection reliability degree. Alternatively, distinctive region detector 11 may detect, as the first distinctive region, a region whose reliability degree obtained by detection performed using machine learning etc. is higher than a certain value.

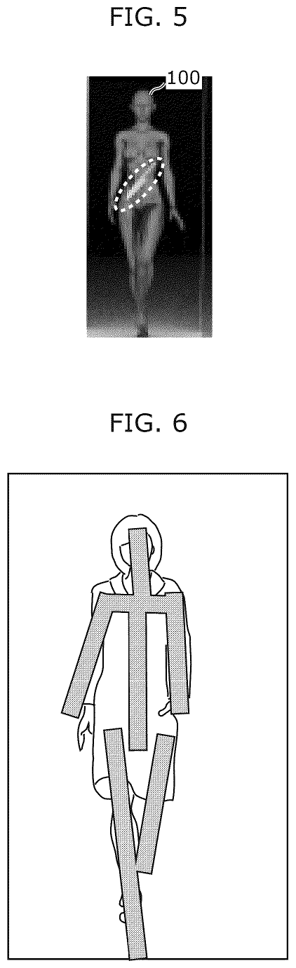

FIG. 5 is a schematic diagram illustrating an example of how distinctive region detector 11 detects the first distinctive region.

As illustrated in FIG. 5, distinctive region detector 11 detects, as the first distinctive region, a region that is in a shape of a knife, surrounded by an ellipse, and has luminance values significantly higher than luminance values of peripheral pixels, for example. Alternatively, distinctive region detector 11 detects, as the first distinctive region, a region that is in a shape of a knife, surrounded by an ellipse, and has luminance values higher than a predetermined luminance value, for example. Alternatively, distinctive region detector 11 detects, as the first distinctive region, a region that is in a shape of a knife, surrounded by an ellipse, and has luminance values significantly higher than pixel values of pixels corresponding to an exposed part of person 100 (e.g., the face or hands), for example.

Referring back to FIG. 2 again, we continue with the description of determination system 1.

Reference position calculator 12 calculates a reference position regarding person 100, from each of the plurality of second images that include person 100, have been captured at mutually different time points by camera 60, and have been captured at substantially the same time as the plurality of first images.

Reference position calculator 12 may calculate, as the reference position, the body region of person 100, for example. Alternatively, reference position calculator 12 may calculate, as the reference position, the skeletal frame of person 100, for example.

Reference position calculator 12 may calculate the reference position using a machine learning model that is pre-trained to output a reference position upon receiving an input of a second image that includes person 100, for example.

FIG. 6 is a schematic diagram illustrating an example of how reference position calculator 12 calculates the skeletal frame of person 100 as the reference position.

As illustrated in FIG. 6, reference position calculator 12 calculates, as the reference position, the skeletal frame of person 100 shown by solid lines, for example.

Referring back to FIG. 2 again, we continue with the description of determination system 1.

When the first distinctive region is detected from one or more first images included in the plurality of first images by distinctive region detector 11, mapper 13 maps, for each of the one or more first images, the first distinctive region detected from the first image onto person 100 included in a second image that has been captured at substantially the same time as the first image, based on the first distinctive region and the reference position calculated by reference position calculator 12 from the second image.

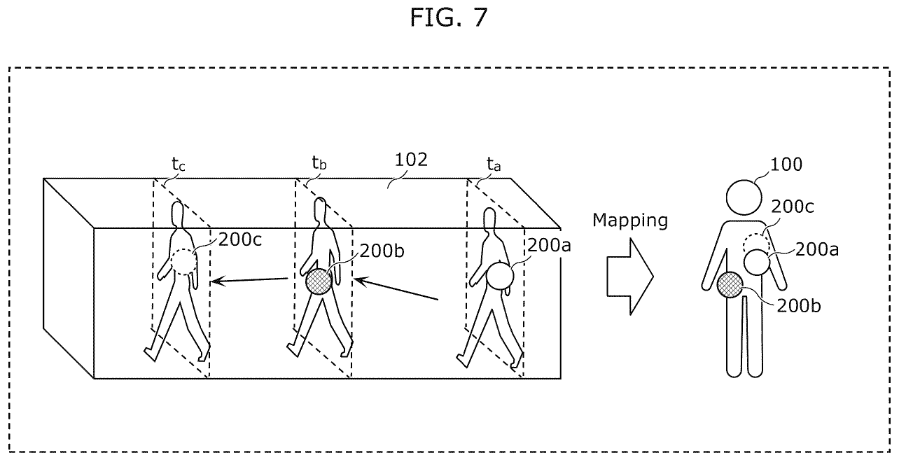

FIG. 7 is a schematic diagram illustrating an example of how mapper 13 maps the first distinctive regions onto person 100 included in a second image.

As illustrated in FIG. 7, for example, mapper 13: maps first distinctive region 200a detected from a first image captured at time point tₐ onto a position below the left armpit of person 100, based on first distinctive region 200a and a reference position calculated from a second image captured at time point tₐ; maps first distinctive region 200b detected from a first image captured at time point t_{b} onto a position of the right hip of person 100, based on first distinctive region 200b and a reference position calculated from a second image captured at time point t_{b}; and maps first distinctive region 200c detected from a first image captured at time point t_{c} onto a position below the left armpit of person 100, based on first distinctive region 200c and a reference position calculated from a second image captured at time point t_{c}. In the case where a reliability degree is calculated for each distinctive region detected, mapper 13 maps information regarding a set of the first distinctive region and the value of the reliability degree.

Note that when, for example, a plurality of persons are included in a first image and/or a second image, mapper 13 may identify each of the plurality of persons and, for each of persons identified to be the same person, map the first distinctive region onto the person included in the second image.

Referring back to FIG. 2 again, we continue with the description of determination system 1.

Determiner 14 determines the possession of person 100 based on the mapping result of mapper 13.

Since the determination of the possession of person 100 is based on the mapping result of mapper 13, determiner 14 can, even when the possession of person 100 moves as person 100 moves, determine the possession of person 100 based on the relative positional relationship between person 100 and the possession.

Determiner 14 may determine the possession of person 100 based on a determination condition regarding, among one or more first images from which the first distinctive regions have been detected, mapping images in which mapper 13 has mapped the first distinctive regions onto substantially the same position on the person.

That is to say, determiner 14 may determine the possession of person 100 based on a determination condition regarding a total number of times mapping has been performed onto substantially the same position on a mapping image, for example. More specifically, determiner 14 may for example, determine that person 100 has a possession when the total number of times mapping has been performed onto substantially the same position on a mapping image is greater than or equal to a predetermined number, and determine that person 100 does not have a possession when the total number of times mapping has been performed onto substantially the same position on a mapping image is less than the predetermined number.

This is based on the fact that, for example, the greater the total number of times the first distinctive regions have been mapped onto a given position on person 100 (e.g., a position below the left armpit of person 100), the higher the possibility that these first distinctive regions are images of one possession held by person 100 in that position, whereas the smaller the total number of times the first distinctive regions have been mapped onto a given position on person 100 (e.g., a position below the left armpit of person 100), the higher the possibility that a region whose luminance happens to be distinctive for some reason has been detected as the first distinctive region.

Alternatively, determiner 14 may determine the possession of person 100 based on, for example, a determination condition regarding (i) a representative luminance representing the first distinctive region in each of mapping images or (ii) a representative value (a sum, maximum, median, mode, etc.) of the detection reliability degree of the first distinctive region in each of the mapping images. More specifically, for example, determiner 14 may determine that person 100 has a possession when the representative luminance representing the first distinctive region in each of the mapping images or the representative value of the detection reliability degree of the first distinctive region in each of the mapping images is a distinctive value (at least a first predetermined value, or at most a second predetermined value lower than the first predetermined value), and determine that person 100 does not have a possession when the representative luminance or the representative value of the detection reliability degree is not a distinctive value (between the first predetermined value and the second predetermined value).

This is based on the fact that, for example, in the case where the first distinctive regions are mapped onto a certain position on person 100 a plurality of times, the larger the representative luminance representing these first distinctive regions or the representative value of the detection reliability degrees of these first distinctive regions, the higher the possibility that these first distinctive regions are images of the same possession, whereas the smaller the representative luminance or the representative value of the detection reliability degrees, the higher the possibility that these first distinctive regions are regions that happen to be distinctive in luminance (higher than the first predetermined value or lower than the second predetermined value) for some reason and have therefore ended up being detected as the first distinctive regions.

Here, the representative luminance may be, for example, the mean of the luminances of a first distinctive region, the median of the luminances of the first distinctive region, or the mode thereof.

Determiner 14 may determine the possession of person 100 based on, for example, a determination condition according to the position onto which the first distinctive region has been mapped.

That is to say, for example, when the first distinctive region is mapped onto a position at which person 100 is relatively likely to have a hazardous material (e.g., a position below an armpit of person 100), determiner 14 may determine the possession of person 100 based on a determination condition under which person 100 is relatively likely to be determined to have a possession, whereas when the first distinctive region is mapped onto a position at which person 100 is relatively less likely to have a hazardous material (e.g., the position of a thigh of person 100), determiner 14 may determine the possession of person 100 based on a determination condition under which person 100 is relatively less likely to be determined to have a possession.

Determiner 14 may determine the type of the possession of person 100 based on, for example, the shape of the first distinctive region.

That is to say, determiner 14 may determine that person 100 has a knife when the first distinctive region is in a shape of a knife, for example. Also, determiner 14 may determine that person 100 has a container for carrying a flammable liquid, etc. when the first distinctive region is in a shape of a container for carrying a flammable liquid, etc., for example.

Determiner 14 may determine either person 100 has a possession or person 100 does not have a possession, or may determine the likelihood of person 100 having a possession, for example.

Outputter 15 outputs the determination result of determiner 14.

For example, outputter 15 may display an image showing the determination result of determiner 14 on a display included in the computer device by which determination device 10 is implemented.

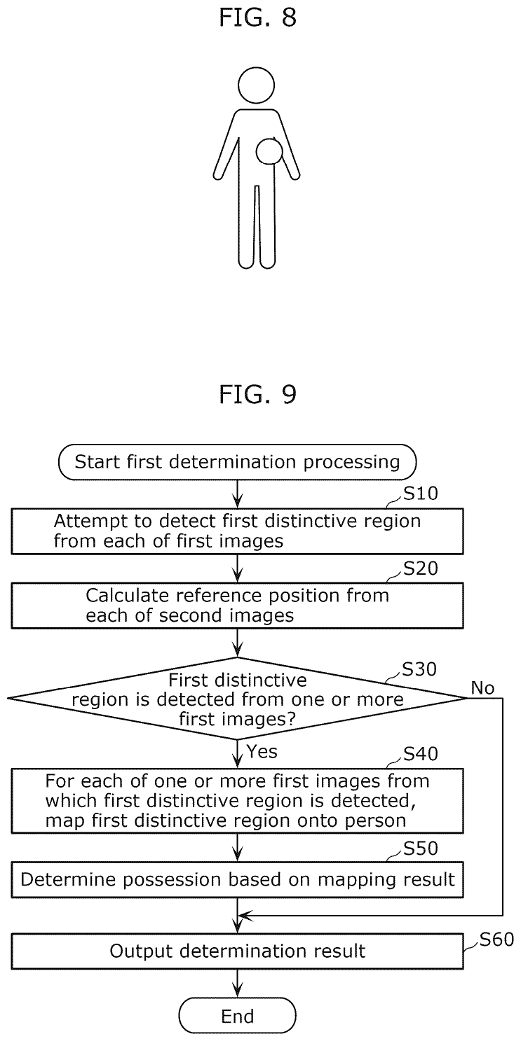

FIG. 8 is a schematic diagram illustrating an example of the image displayed by outputter 15 on the display.

As illustrated in FIG. 8, for example, in the case where: determiner 14 has determined that person 100 has a possession; and mapper 13 has mapped the first distinctive region corresponding to the possession onto the position below the left armpit of person 100, outputter 15 may display an image showing that the possession is detected at the position below the left armpit of person 100.

### [Operation]

The following describes operation performed by determination system 1 having the above-described configuration.

In determination system 1, determination device 10 performs first determination processing of determining the possession of person 100 based on: a plurality of first images that include person 100 and have been captured at mutually different time points by camera 51; and a plurality of second images that include person 100, have been captured at mutually different time points by camera 60, and have been captured at substantially the same time as the plurality of first images.

FIG. 9 is a flowchart of the first determination processing.

The first determination processing starts when, for example, camera 51 outputs the plurality of first images that include person 100 and have been captured at mutually different time points and camera 60 outputs the plurality of second images that include person 100, have been captured at mutually different time points, and have been captured at substantially the same time as the plurality of first images.

As illustrated in FIG. 9, when the first determination processing starts, distinctive region detector 11 attempts to detect the first distinctive region that is a characteristic luminance distribution region, from each of the plurality of first images that include person 100 and have been captured at mutually different time points by camera 51 (step S10).

Reference position calculator 12 calculates a reference position from each of the plurality of second images that include person 100, have been captured at mutually different time points by camera 60, and have been captured at substantially the same time as the plurality of first images (step S20).

Next, mapper 13 checks whether or not the first distinctive region is detected from one or more first images included in the plurality of first images by distinctive region detector 11 (step S30).

When the first distinctive region is detected from one or more first images in the processing of step S30 (Yes in step S30), mapper 13 maps, for each of the one or more first images, the first distinctive region detected from the first image onto person 100 included in a second image that has been captured at substantially the same time as the first image, based on the first distinctive region and the reference position calculated by reference position calculator 12 from the second image (step S40).

When all the first distinctive regions detected are mapped onto person 100 included in the second images, determiner 14 determines the possession of person 100 based on the mapping result of mapper 13 (step S50).

When determiner 14 determines the possession of person 100, outputter 15 outputs the determination result of determiner 14 (step S60).

When the first distinctive region is not detected from one or more first images in the processing of step S30 (No in step S30), determiner 14 determines that person 100 does not have a possession, and outputter 15 outputs the determination result of determiner 14 (step S60). When the processing of step S60 is finished, determination device 10 finishes the first determination processing.

### <Consideration>

When person 100 passes through pathway 101, the possession of person 100 faces in various directions as person 100 moves. Therefore, first images, which are a plurality of sub-terahertz wave images captured by camera 51, show images that are based on sub-terahertz waves reflected by the possession facing in various directions.

When one or more first images include a distinctive region, which is a characteristic luminance distribution region attributable to a possession of person 100, the distinctive regions are mapped onto person 100. Thus, even when the possession of person 100 moves along with movement of person 100, determiner 14 can determine the possession of person 100 based on the relative positional relationship between person 100 and the possession.

As described above, determination device 10 having the above-described configuration can determine the possession of person 100 with relatively high accuracy by using sub-terahertz wave images that include person 100.

### Embodiment 2

The following describes a determination system according to Embodiment 2 which is configured by modifying determination system 1 according to Embodiment 1.

In the following description, constituent elements of the determination system according to Embodiment 2 which are common to the determination system according to Embodiment 1 are given the same reference signs, and the detailed descriptions thereof will be omitted as they have already been described. The determination system according to Embodiment 2 will be described with focus on the differences from determination system 1.

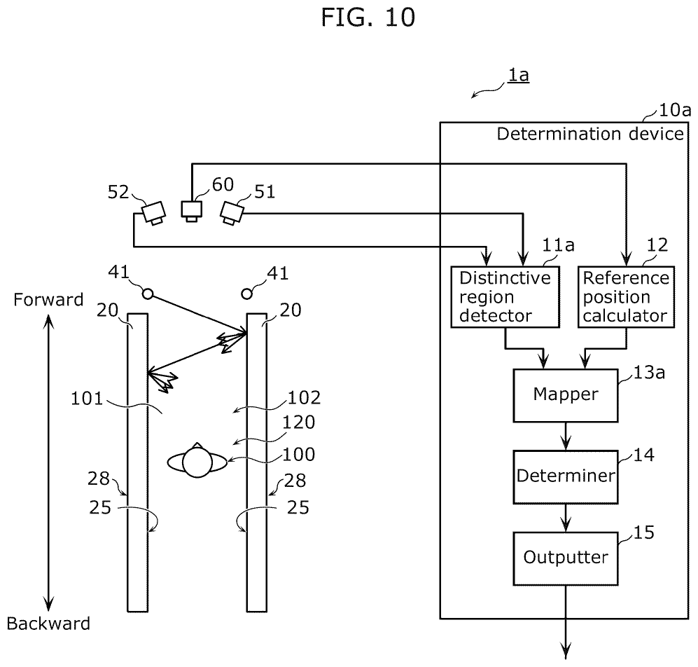

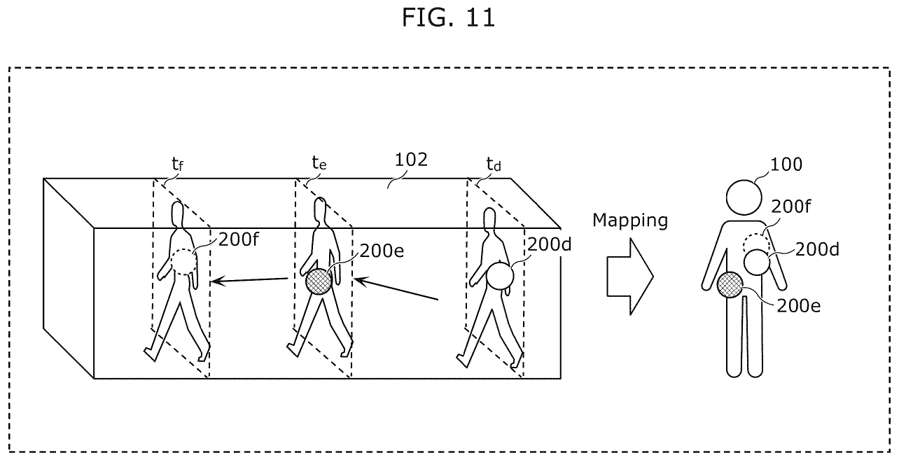

FIG. 10 is a block diagram illustrating a configuration of determination system 1a according to Embodiment 2.

As illustrated in FIG. 10, determination system 1a is configured by adding camera 52 to determination system 1 according to Embodiment 1 and changing determination device 10 of determination system 1 to determination device 10a. Determination device 10a is configured by changing distinctive region detector 11 and mapper 13 of determination device 10 to distinctive region detector 11a and mapper 13a, respectively.

Camera 52 has the same function as camera 51, and captures a third image that includes person 100 and is a sub-terahertz wave image by receiving sub-terahertz waves that are emitted from first light sources 41, then diffusely reflected by reflectors 20, and reflected by person 100.

Camera 52 captures video. Thus, camera 52 captures a plurality of third images at mutually different time points. Camera 52 then outputs the plurality of third images captured to determination device 10a.

Camera 52 captures third images in synchronization with the imaging performed by camera 51. More specifically, camera 52 captures the third images at substantially the same time as when camera 51 captures the first images. Therefore, the plurality of third images captured by camera 52 are images captured at substantially the same time as the first images captured by camera 51. This means that the plurality of second images captured by camera 60 are images captured at substantially the same time as the third images captured by camera 52.

Camera 52 is located forward of the center of imaging space 102 in the extending direction of pathway 101, and is located at a position where camera 52 captures images of person 100 at an angle different from the angle at which camera 51 captures images of person 100. Camera 52 is supported by, for example, a support member not illustrated in the drawings.

Distinctive region detector 11a has the function that distinctive region detector 11 according to Embodiment 1 has (i.e., attempts to detect the first distinctive region that is a characteristic luminance distribution region). Distinctive region detector 11a further attempts to detect a second distinctive region that is a characteristic luminance distribution region, from each of the plurality of third images that include person 100 and have been captured at mutually different time points by camera 52.

Mapper 13a has the function that mapper 13 according to Embodiment 1 has (i.e., maps the first distinctive region onto person 100 in a second image). When the second distinctive region is detected from one or more third images included in the plurality of third images by distinctive region detector 11a, mapper 13a further maps, for each of the one or more third images, the second distinctive region detected from the third image onto person 100 included in a second image that has been captured at substantially the same time as the third image, based on the second distinctive region and the reference position calculated by reference position calculator 12 from the second image.

FIG. 11 is a schematic diagram illustrating an example of how mapper 13a maps first distinctive regions and a second distinctive region onto person 100 included in a second image.

As illustrated in FIG. 11, for example, mapper 13a: maps first distinctive region 200d detected from a first image captured at time point t_{d} onto a position below the left armpit of person 100, based on first distinctive region 200d and a reference position calculated from a second image captured at time point t_{d}; maps first distinctive region 200e detected from a first image captured at time point tₑ onto a position of the right hip of person 100, based on first distinctive region 200e and a reference position calculated from a second image captured at time point tₑ; and maps second distinctive region 200f detected from a third image captured at time point t_{f} onto a position below the left armpit of person 100, based on second distinctive region 200f and the reference position calculated from a second image captured at time point t_{f}.

### [Operation]

The following describes operation performed by determination system 1a having the above-described configuration.

In determination system 1a, determination device 10a performs second determination processing instead of the first determination processing according to Embodiment 1. The second determination processing is processing of determining a possession of person 100 based on: a plurality of first images that include person 100 and have been captured at mutually different time points by camera 51; a plurality of second images that include person 100, have been captured at mutually different time points by camera 60, and have been captured at substantially the same time as the plurality of first images; and a plurality of third images that include person 100, have been captured at mutually different time points by camera 52, and have been captured at substantially the same time as the plurality of first images and the plurality of second images.

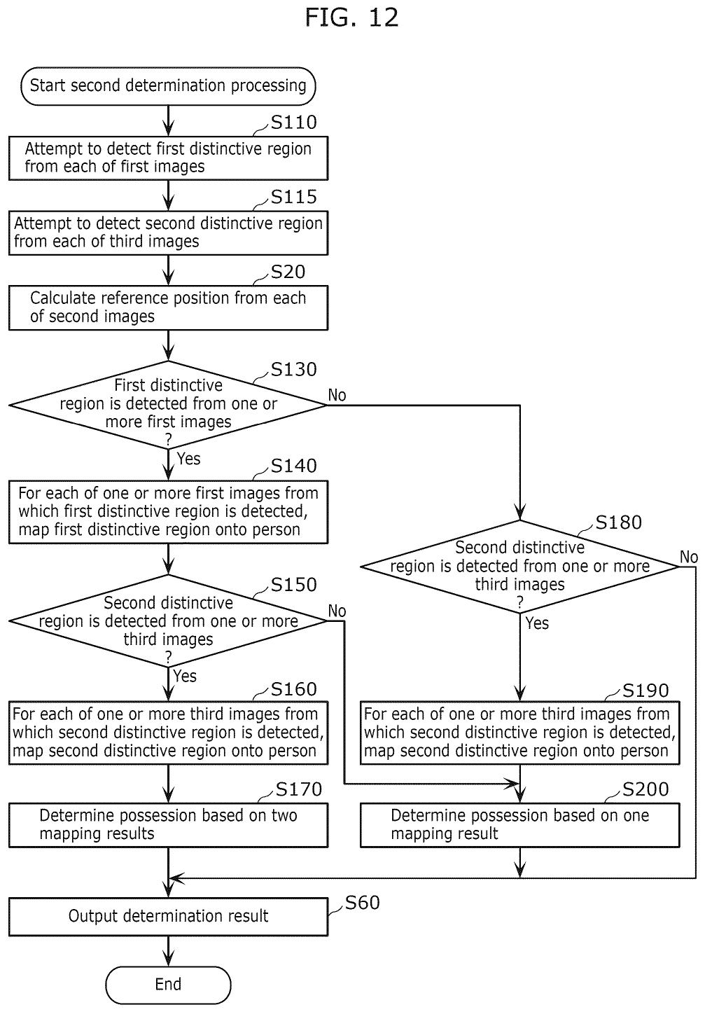

FIG. 12 is a flowchart of the second determination processing.

The second determination processing starts when, for example: camera 51 outputs the plurality of first images that include person 100 and have been captured at mutually different time points; camera 60 outputs the plurality of second images that include person 100, have been captured at mutually different time points, and have been captured at substantially the same time as the plurality of first images; and camera 52 outputs the plurality of third images that include person 100, have been captured at mutually different time points, and have been captured at substantially the same time as the plurality of first images.

As illustrated in FIG. 12, the second determination processing is processing obtained by changing the processing of step S10, the processing of step S30, and the processing of step S40 included in the first determination processing according to Embodiment 1 to the processing of step S110, the processing of step S130, and the processing of step S140, respectively, and adding the processing of step S115, the processing of step S150, the processing of step S160, the processing of step S170, the processing of step S180, the processing of step S190, and the processing of step S200.

As illustrated in FIG. 12, when the second determination processing starts, distinctive region detector 11a attempts to detect the first distinctive region that is a characteristic luminance distribution region, from each of the plurality of first images that include person 100 and have been captured at mutually different time points by camera 51 (step S110).

Next, distinctive region detector 11a attempts to detect the second distinctive region that is a characteristic luminance distribution region, from each of the plurality of third images that include person 100 and have been captured at mutually different time points by camera 52 (step S115).

When the processing of step S115 is finished, the processing proceeds to step S20.

When the processing of step S20 is finished, mapper 13a checks whether or not the first distinctive region is detected from one or more first images included in the plurality of first images by distinctive region detector 11a (step S130).

When the first distinctive region is detected from one or more first images in the processing of step S130 (Yes in step S130), mapper 13a maps, for each of the one or more first images, the first distinctive region detected from the first image onto person 100 included in a second image that has been captured at substantially the same time as the first image, based on the first distinctive region and the reference position calculated by reference position calculator 12 from the second image (step S140).

When all the first distinctive regions detected are mapped onto person 100 included in the second images, mapper 13a checks whether or not the second distinctive region is detected from one or more third images included in the plurality of third images by distinctive region detector 11a (step S150).

When the second distinctive region is detected from one or more third images in the processing of step S150 (Yes in step S150), mapper 13a maps, for each of the one or more third images, the second distinctive region detected from the third image onto person 100 included in a second image that has been captured at substantially the same time as the third image, based on the second distinctive region and the reference position calculated by reference position calculator 12 from the second image (step S160).

When all the second distinctive regions detected are mapped onto person 100 included in the second images, determiner 14 determines the possession of person 100 based on the mapping results of mapper 13 (step S170). That is to say, determiner 14 determines the possession of person 100 based on two mapping results, i.e., the mapping result obtained by mapping the first distinctive regions and the mapping result obtained by mapping the second distinctive regions.

When the first distinctive region is not detected from one or more first images in the processing of step S130 (No in step S130), mapper 13a checks whether or not the second distinctive region is detected from one or more third images included in the plurality of third images by distinctive region detector 11a (step S180).

When the second distinctive region is detected from one or more third images in the processing of step S180 (Yes in step S180), mapper 13a maps, for each of the one or more third images, the second distinctive region detected from the third image onto person 100 included in a second image that has been captured at substantially the same time as the third image, based on the second distinctive region and the reference position calculated by reference position calculator 12 from the second image (step S190).

When the second distinctive region is not detected from one or more third images in the processing of step S150 and when the processing of step S190 is finished, determiner 14 determines the possession of person 100 based on the mapping result of mapper 13 (step S200). That is to say, determiner 14 determines the possession of person 100 based on one of the following mapping results of mapping which has been performed: the mapping result obtained by mapping the first distinctive regions and the mapping result obtained by mapping the second distinctive regions.

When the processing of step S170 is finished, when the processing of step S200 is finished, and when the second distinctive region is not detected from one or more third images in the processing of step S180 (No in step S180), the processing proceeds to step S60.

When the processing of step S60 is finished, determination device 10a finishes the second determination processing.

### <Consideration>

Determination device 10a having the above-described configuration determines the possession further based on the third images in addition to the first images and the second images.

Thus, determination device 10a having the above-described configuration can determine the possession with higher accuracy by also mapping, onto the same person, the result of detection from the third images captured at the position different from the position at which the first images are captured.

### Embodiment 3

The following describes a determination system according to Embodiment 3 which is configured by modifying determination system 1 according to Embodiment 1.

In the following description, constituent elements of the determination system according to Embodiment 3 which are common to determination system 1 according to Embodiment 1 are given the same reference signs, and the detailed descriptions thereof will be omitted as they have already been described. The determination system according to Embodiment 3 will be described with focus on the differences from determination system 1.

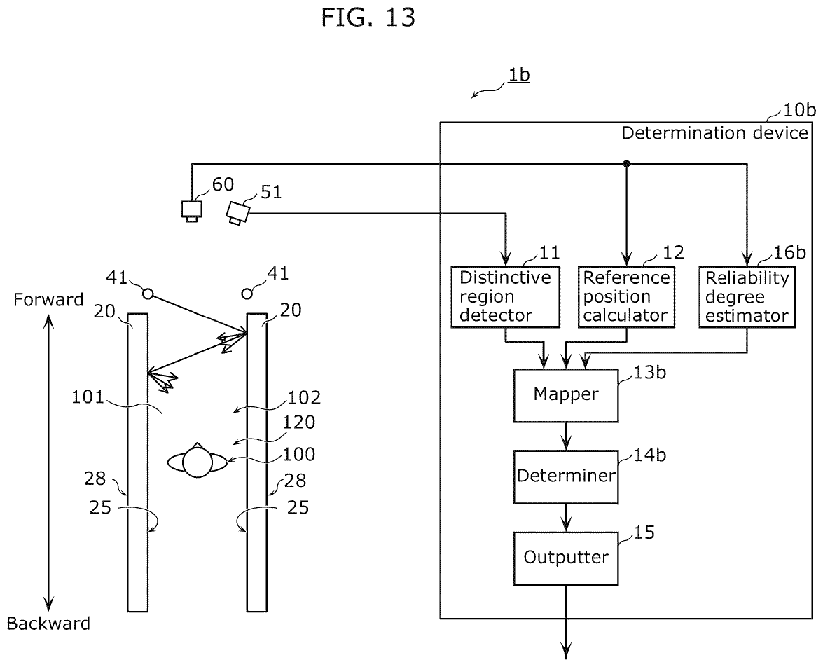

FIG. 13 is a block diagram illustrating a configuration of determination system 1b according to Embodiment 3.

As illustrated in FIG. 13, determination system 1b is configured by changing determination device 10 of determination system 1 according to Embodiment 1 to determination device 10b. Determination device 10b is configured by changing mapper 13 and determiner 14 of determination device 10 to mapper 13b and determiner 14b, respectively, and adding reliability degree estimator 16b.

Reliability degree estimator 16b estimates, from a second image that includes person 100, a detection reliability degree indicating the reliability degree of detection from a first image.

Reliability degree estimator 16b may estimate the detection reliability degree using a machine learning model that is pre-trained to output variations in the luminance of a first image upon receiving an input of a second image that includes person 100, for example. Alternatively, reliability degree estimator 16b may for example, identify the position and the posture of person 100 in pathway 101 from a second image, and estimate the detection reliability degree based on the identified position and posture of person 100 in pathway 101.

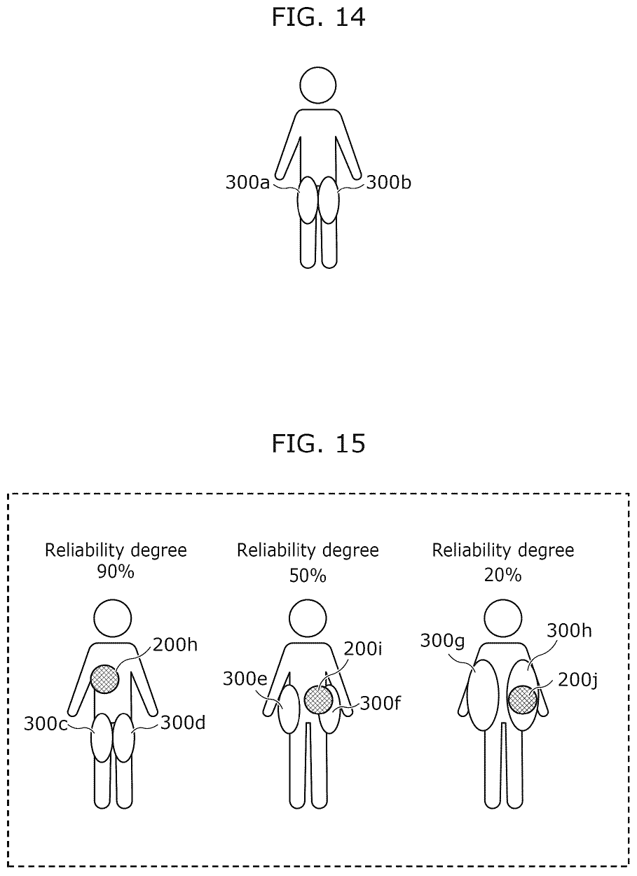

FIG. 14 is a schematic diagram illustrating an example of how reliability degree estimator 16b estimates detection reliability degrees from a second image.

As illustrated in FIG. 14, reliability degree estimator 16b estimates that the detection reliability degrees of region 300a and region 300b located at the thighs are relatively low and the detection reliability degrees of the other regions are relatively high, for example.

Referring back to FIG. 13 again, we continue with the description of determination system 1b.

When the first distinctive region is detected from one or more first images included in the plurality of first images by distinctive region detector 11, mapper 13b maps, for each of the one or more first images, the first distinctive region detected from the first image and the detection reliability degree estimated by reliability degree estimator 16b from a second image that has been captured at substantially the same time as the first image, onto person 100 included in the second image, based on the first distinctive region, the reference position calculated by reference position calculator 12 from the second image, and the detection reliability degree.

FIG. 15 is a schematic diagram illustrating examples of how mapper 13b maps the first distinctive region and the detection reliability degrees onto person 100 included in the second image.

As illustrated in FIG. 15, for example, mapper 13b may: map region 300c and region 300d whose detection reliability degrees are estimated to be relatively low and first distinctive region 200h onto person 100 included in a second image; map region 300e and region 300f whose detection reliability degrees are estimated to be relatively low and first distinctive region 200i onto person 100 included in a second image; or map region 300g and region 300h whose detection reliability degrees are estimated to be relatively low and first distinctive region 200j onto person 100 included in a second image.

Referring back to FIG. 13 again, we continue with the description of determination system 1b.

Determiner 14b determines the possession of person 100 based on the mapping result of mapper 13.

For example, determiner 14b may determine the possession of person 100, assuming that the reliability degree of the first distinctive region located in a region whose detection reliability degree is estimated to be relatively high by reliability degree estimator 16b is relatively high whereas the reliability degree of the first distinctive region located in a region whose detection reliability degree is estimated to be relatively low by reliability degree estimator 16b is relatively low.

As illustrated in FIG. 15, for example, determiner 14b may: calculate 90% as the reliability degree of first distinctive region 200h mapped onto a position not overlapping regions 300c and 300d whose detection reliability degrees are estimated to be relatively low; calculate 50% as the reliability degree of first distinctive region 200i mapped onto a position partially but not completely overlapping regions 300e and region 300f whose detection reliability degrees are estimated to be relatively low; calculate 20% as the reliability degree of first distinctive region 200j mapped onto a position completely overlapping regions 300g and 300h whose detection reliability degrees are estimated to be relatively low; and determine the possession of person 100 based on the reliability degrees calculated.

### [Operation]

The following describes operation performed by determination system 1b having the above-described configuration.

In determination system 1b, determination device 10b performs third determination processing instead of the first determination processing according to Embodiment 1. As with the first determination processing, the third determination processing is processing of determining a possession of person 100 based on: a plurality of first images that include person 100 and have been captured at mutually different time points by camera 51; and a plurality of second images that include person 100, have been captured at mutually different time points by camera 60, and have been captured at substantially the same time as the plurality of first images.

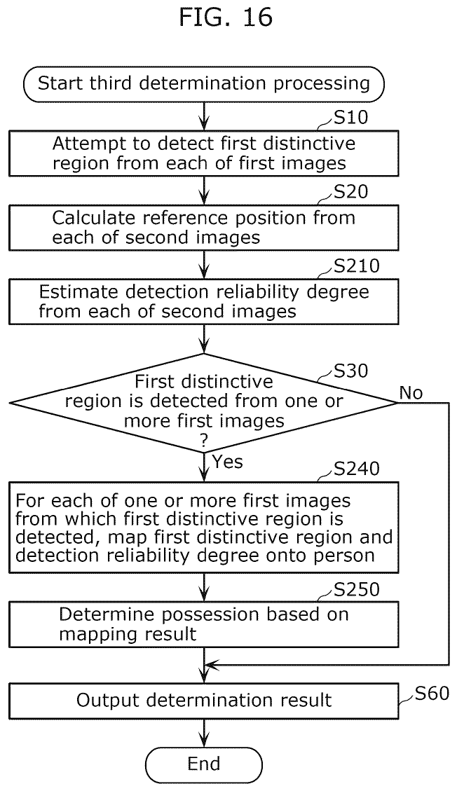

FIG. 16 is a flowchart of the third determination processing.

The third determination processing starts when, for example, camera 51 outputs the plurality of first images that include person 100 and have been captured at mutually different time points and camera 60 outputs the plurality of second images that include person 100, have been captured at mutually different time points, and have been captured at substantially the same time as the plurality of first images.

As illustrated in FIG. 16, the third determination processing is processing obtained by changing the processing of step S40 and the processing of step S50 included in the first determination processing according to Embodiment 1 to the processing of step S240 and the processing of step S250, respectively, and adding the processing of step S210.

As illustrated in FIG. 16, when the processing of step S20 is finished, reliability degree estimator 16b estimates, from each of the plurality of second images, the detection reliability degree indicating the reliability degree of detection from the first image that has been captured at substantially the same time as the second image (step S210).

When the processing of step S210 is finished, the processing proceeds to step S30.

When the first distinctive region is detected from one or more first images in the processing of step S30 (Yes in step S30), mapper 13b maps, for each of the one or more first images, the first distinctive region detected from the first image and the detection reliability degree estimated by reliability degree estimator 16b from a second image that has been captured at substantially the same time as the first image, onto person 100 included in the second image, based on the first distinctive region, the reference position calculated by reference position calculator 12 from the second image, and the detection reliability degree (step S240).

When the first distinctive regions and the detection reliability degrees are mapped, determiner 14b determines the possession of person 100 based on the mapping result of mapper 13 (step S250).

When the processing of step S250 is finished and when the first distinctive region is not detected from one or more first images in the processing of step S30 (No in step S30), the processing proceeds to step S60.

When the processing of step S60 is finished, determination device 10b finishes the third determination processing.

### <Consideration>

Determination device 10b having the above-described configuration determines the possession further based on the detection reliability degree.

Thus, determination device 10b having the above-described configuration can determine the possession with higher accuracy.

### Embodiment 4

The following describes a determination system according to Embodiment 4 which is configured by modifying determination system 1 according to Embodiment 1.

In the following description, constituent elements of the determination system according to Embodiment 4 which are common to determination system 1 according to Embodiment 1 are given the same reference signs, and the detailed descriptions thereof will be omitted as they have already been described. The determination system according to Embodiment 4 will be described with focus on the differences from determination system 1.

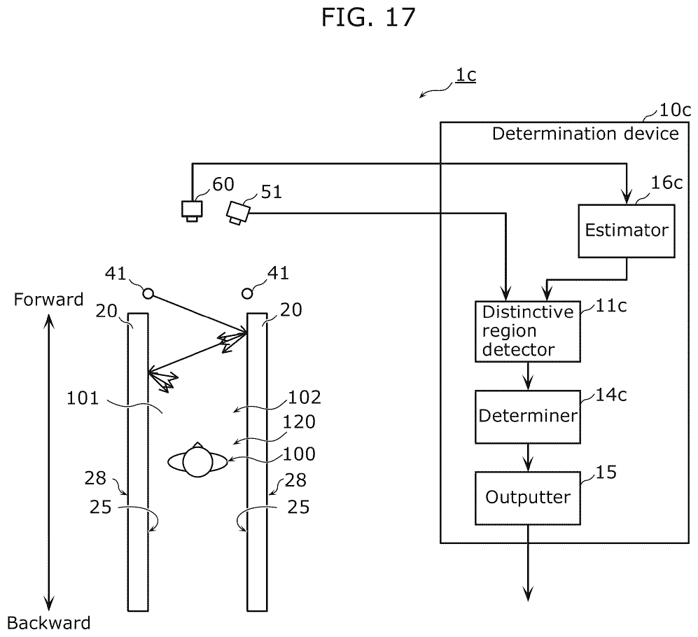

FIG. 17 is a block diagram illustrating a configuration of determination system 1c according to Embodiment 4.

As illustrated in FIG. 17, determination system 1c is configured by changing determination device 10 of determination system 1 according to Embodiment 1 to determination device 10c. Determination device 10c is configured by removing reference position calculator 12 and mapper 13 from determination device 10, changing distinctive region detector 11 and determiner 14 of determination device 10 to distinctive region detector 11c and determiner 14c, respectively, and adding estimator 16c.

Estimator 16c estimates, from a second image that includes person 100, a virtual sub-terahertz wave image which would be captured at substantially the same time as the second image if sub-terahertz waves were emitted to person 100.

Estimator 16c may for example, estimate the virtual sub-terahertz wave image using a machine learning model that is pre-trained to output a virtual sub-terahertz wave image upon receiving an input of a second image that includes person 100. Alternatively, estimator 16c may for example, identify the position and the posture of person 100 in pathway 101 from a second image and estimate the virtual sub-terahertz wave image based on the identified position and posture of person 100 in pathway 101.

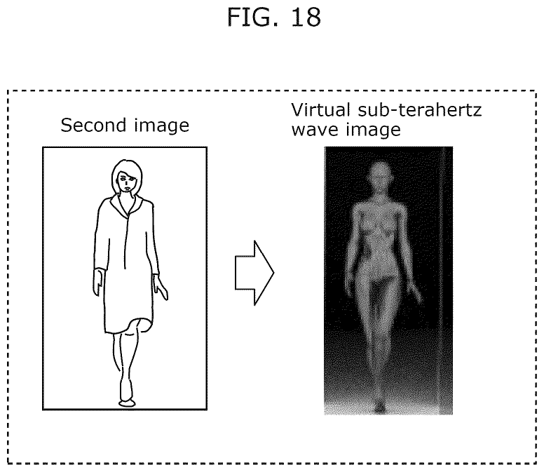

FIG. 18 is a schematic diagram illustrating an example of how estimator 16c estimates a virtual sub-terahertz wave image from a second image.

As illustrated in FIG. 18, estimator 16c estimates a virtual sub-terahertz wave image having pixel values that indicate luminances, for example.

As described above, estimator 16c estimates a virtual sub-terahertz wave image from a second image that is a visible light image. Thus, when person 100 has a possession at a position, such as under clothing or in a bag, from which the visible light cannot directly reach camera 51, estimator 16c estimates a virtual sub-terahertz wave image that does not include the possession.

Referring back to FIG. 17 again, we continue with the description of determination system 1c.

Distinctive region detector 11c attempts to detect, from a first image that includes person 100 and has been captured at substantially the same time as the second image, the first distinctive region that is a characteristic luminance distribution region, based on the virtual sub-terahertz wave image estimated by estimator 16c and the first image.

Distinctive region detector 11c may for example, compare pixel values of pixels of the virtual sub-terahertz wave image that indicate luminances with pixel values of pixels of the first image that indicate luminances, and when there is a region where the difference between pixel values indicating luminances of the virtual sub-terahertz wave image and pixel values indicating luminances of the first image is greater than or equal to a predetermined value, distinctive region detector 11c may detect that region as the first distinctive region.

Alternatively, distinctive region detector 11c may detect the first distinctive region using a machine learning model that is pre-trained to output a first distinctive region upon receiving inputs of a first image and a virtual sub-terahertz wave image, for example.

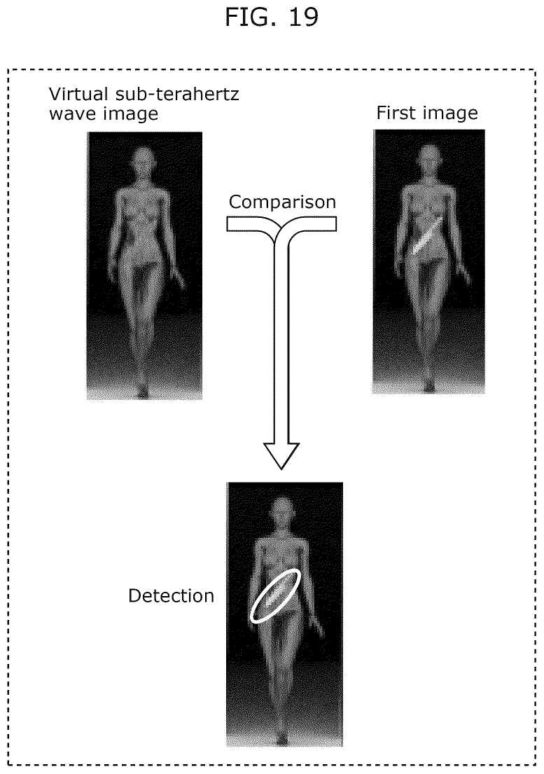

FIG. 19 is a schematic diagram illustrating an example of how distinctive region detector 11c detects the first distinctive region based on a virtual sub-terahertz wave image and a first image.

As illustrated in FIG. 19, distinctive region detector 11c detects, as the first distinctive region, a region which is, for example, in a shape of a knife and surrounded by an ellipse and in which the difference between pixel values indicating luminances is greater than or equal to a predetermined value.

Referring back to FIG. 17 again, we continue with the description of determination system 1c.

Determiner 14c determines the possession of person 100 based on the first distinctive region detected by distinctive region detector 11c.

Determiner 14c may for example, determine that person 100 has a possession when distinctive region detector 11c detects the first distinctive region, and determine that person 100 does not have a possession when distinctive region detector 11c does not detect the first distinctive region.

Note that the first image may be used in generating the virtual sub-terahertz wave image. This makes it possible to generate a virtual sub-terahertz wave image that is more precise.

### [Operation]

The following describes operation performed by determination system 1c having the above-described configuration.

In determination system 1c, determination device 10c performs fourth determination processing instead of the first determination processing according to Embodiment 1. The fourth determination processing is processing of determining a possession of person 100 based on one first image that includes person 100 and has been captured by camera 51 and one second image that includes person 100 and has been captured by camera 60 at substantially the same time as the one first image.

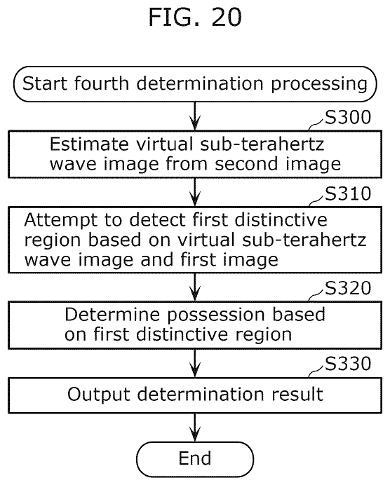

FIG. 20 is a flowchart of the fourth determination processing.

The fourth determination processing starts when, for example, camera 51 outputs one first image that includes person 100 and camera 60 outputs one second image that has been captured at substantially the same time as the one first image and includes person 100.

As illustrated in FIG. 20, when the fourth determination processing starts, estimator 16c estimates, from a second image that includes person 100 and has been captured by camera 60, a virtual sub-terahertz wave image which would be captured at substantially the same time as the second image if sub-terahertz waves were emitted to person 100 (step S300).

When estimator 16c estimates the virtual sub-terahertz wave image, distinctive region detector 11c attempts to detect the first distinctive region based on the virtual sub-terahertz wave image estimated by estimator 16c and the first image that includes person 100 and has been captured at substantially the same time as the second image from which estimator 16c has estimated the virtual sub-terahertz wave image (step S310).

When the attempt to detect the first distinctive region is performed by distinctive region detector 11c, determiner 14c determines a possession of person 100 based on the first distinctive region (step S320).

When determiner 14c determines the possession of person 100, outputter 15 outputs the determination result of determiner 14c (step S330).

When the processing of step S330 is finished, determination device 10c finishes the fourth determination processing.

### <Consideration>

Determination device 10c having the above-described configuration estimates a virtual sub-terahertz wave image from a second image. Specifically, from a second image that does not show the possession of person 100 due to the possession being concealed by clothing, a bag, or the like and has been captured at substantially the same time as a first image which is a sub-terahertz wave image, determination device 10d estimates a virtual sub-terahertz wave image which would be captured at the time of capturing the second image. The possession is then determined based on the estimated virtual sub-terahertz wave image and the first image which is a sub-terahertz wave image that has been actually captured.

Thus, determination device 10c having the above-described configuration can determine the possession of person 100 with relatively high accuracy by using a sub-terahertz wave image that includes person 100.

### Embodiment 5

The following describes a determination system according to Embodiment 5 which is configured by modifying determination system 1 according to Embodiment 1.

In the following description, constituent elements of the determination system according to Embodiment 5 which are common to determination system 1 according to Embodiment 1 and determination system 1b according to Embodiment 3 are given the same reference signs, and the detailed descriptions thereof will be omitted as they have already been described. The determination system according to Embodiment 5 will be described with focus on the differences from determination system 1 and determination system 1b.

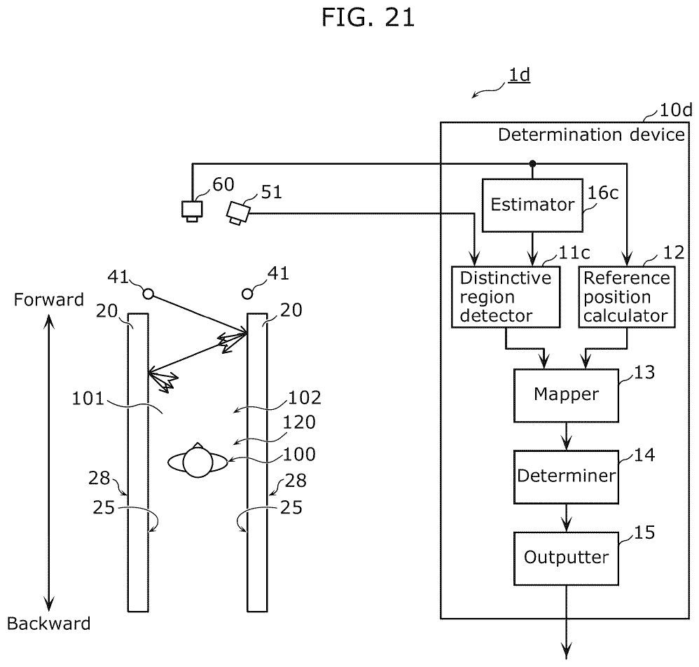

FIG. 21 is a block diagram illustrating a configuration of determination system 1d according to Embodiment 5.

As illustrated in FIG. 21, determination system 1d is configured by changing determination device 10 of determination system 1 according to Embodiment 1 to determination device 10d. Determination device 10d is configured by changing distinctive region detector 11 of determination device 10 to distinctive region detector 11c, and adding estimator 16c.

### [Operation]

The following describes operation performed by determination system 1d having the above-described configuration.

In determination system 1d, determination device 10d performs fifth determination processing instead of the first determination processing according to Embodiment 1. As with the first determination processing, the fifth determination processing is processing of determining a possession of person 100 based on: a plurality of first images that include person 100 and have been captured at mutually different time points by camera 51; and a plurality of second images that include person 100, have been captured at mutually different time points by camera 60, and have been captured at substantially the same time as the plurality of first images.

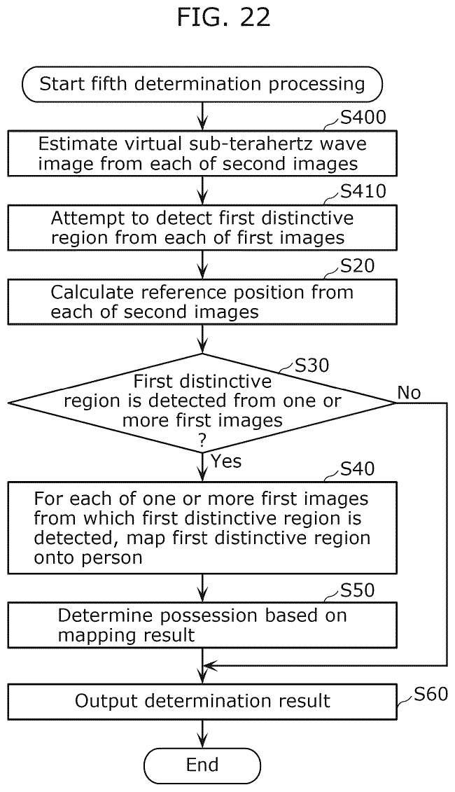

FIG. 22 is a flowchart of the fifth determination processing.

The fifth determination processing starts when, for example, camera 51 outputs the plurality of first images that include person 100 and have been captured at mutually different time points and camera 60 outputs the plurality of second images that include person 100, have been captured at mutually different time points, and have been captured at substantially the same time as the plurality of first images.

As illustrated in FIG. 22, the fifth determination processing is processing obtained by adding the processing of step S400 to the first determination processing according to Embodiment 1 and changing the processing of step S10 to the processing of step S410.

As illustrated in FIG. 22, when the fifth determination processing starts, estimator 16c estimates, from each of the second images that include person 100 and have been captured by camera 60, a virtual sub-terahertz wave image which would be captured at substantially the same time as the second image if sub-terahertz waves were emitted to person 100 (step S400).

When the processing of step S400 is finished, distinctive region detector 11c attempts to detect the first distinctive region from each of the plurality of first images that include person 100 and have been captured at mutually different time points by camera 51, based on the virtual sub-terahertz wave image estimated by estimator 16c and a first image that includes person 100 and has been captured at substantially the same time as the second image from which estimator 16c has estimated the virtual sub-terahertz wave image (step S410).

When the processing of step S410 is finished, the processing proceeds to step S20.

When the processing of step S60 is finished, determination device 10d finishes the fifth determination processing.

### <Consideration>

Determination device 10d having the above-described configuration estimates a virtual sub-terahertz wave image from a second image. Specifically, from a second image that does not show the possession of person 100 due to the possession being concealed by clothing, a bag, or the like and has been captured at substantially the same time as a first image which is a sub-terahertz wave image, determination device 10d estimates a virtual sub-terahertz wave image which would be captured at the time of capturing the second image. The first distinctive region is then detected based on the estimated sub-terahertz wave image and the first image which is a sub-terahertz wave image that has been actually captured.

Thus, as with determination device 10 according to Embodiment 1, determination device 10d having the above-described configuration can determine the possession of person 100 with relatively high accuracy by using a sub-terahertz wave image that includes person 100.

### Supplemental Information

Hereinbefore, determination systems according to the present disclosure have been described based on Embodiments 1 to 5, but the present disclosure is not limited to such embodiments and variations. Various modifications of the embodiments as well as embodiments resulting from combinations of constituent elements from different embodiments and variations that may be conceived by those skilled in the art are intended to be included within the scope of one or more aspects of the present disclosure so long as these do not depart from the essence of the present disclosure.

(1) In Embodiments 1 through 5, each constituent element of determination devices 10 through 10d may be implemented by means of a program executing unit, such as a central processing unit (CPU) or a processor, reading and executing a software program recorded on a recording medium such as a hard disk or a semiconductor memory, or may be a circuit (or an integrated circuit). These circuits may be configured as a single circuit or may be individual circuits. Moreover, these circuits may be general-purpose circuits, or may be specialized circuits.

(2) General or specific aspects of the present disclosure may be implemented as a system, device, method, integrated circuit, computer program, or non-transitory computer-readable recording medium such as a compact disk read-only memory (CD-ROM). The general or specific aspects may also be implemented as any combination of systems, devices, methods, integrated circuits, computer programs, or non-transitory recording media. For example, the present disclosure may be implemented as a program for causing a computer to execute the control performed by controllers or the like included in the constituent elements of the determination devices.

(3) In Embodiments 1 through 5, the processing orders of the processes included in the operations of determination devices 10 through 10d are mere examples. The processing orders of the processes may be changed, and some of the processes may be performed in parallel.

### INDUSTRIAL APPLICABILITY

The present disclosure is widely applicable to determination systems etc. that determine objects.

1. A determination device comprising:
a distinctive region detector that detects a first distinctive region from each of a plurality of first images that include a person and have been captured at mutually different time points, the first distinctive region being a characteristic luminance distribution region;
a reference position calculator that calculates a body region or a skeletal frame of the person from each of a plurality of second images that include the person and have been captured at substantially a same time as the plurality of first images, the body region or the skeletal frame being a reference position regarding movement of the person;
a mapper that, when the distinctive region detector detects the first distinctive region from one or more first images included in the plurality of first images, maps, for each of the one or more first images, the first distinctive region detected from the first image onto the person included in one second image that is included in the plurality of second images and has been captured at substantially a same time as the first image, based on the first distinctive region and the reference position calculated by the reference position calculator from the one second image;
a determiner that determines a possession of the person based on a relative positional relationship between the person and the first distinctive region in a mapping result of the mapper; and
an outputter that outputs a determination result of the determiner,
wherein each of the plurality of first images is a sub-terahertz wave image, and
each of the plurality of second images is at least one of a visible light image, an infrared light image, or a distance image.

2. The determination device according to claim 1,
wherein the determiner determines the possession of the person based on a first determination condition regarding, among the one or more first images, mapping images in each of which the mapper has mapped the first distinctive region onto substantially a same position on the person.

3. The determination device according to claim 2,
wherein the first determination condition is a determination condition regarding a total number of times mapping has been performed onto substantially a same position on each of the mapping images.

4. The determination device according to claim 2,
wherein the first determination condition is a determination condition regarding (i) a representative luminance representing the first distinctive region in each of the mapping images or (ii) a detection reliability degree of the first distinctive region in each of the mapping images.

5. The determination device according to claim 2,
wherein the determiner determines the possession of the person based on the first determination condition according to a position of the first distinctive region mapped in each of the mapping images.

6. The determination device according to claim 2,
wherein the determiner further determines a type of the possession based on a shape of the first distinctive region mapped in each of the mapping images.

7. The determination device according to claim 1,
wherein the distinctive region detector detects, as the first distinctive region, a region having a luminance higher than a first threshold or a region having a luminance lower than a second threshold that is lower than the first threshold.

8. The determination device according to claim 1, further comprising:
a reliability degree estimator that estimates, from each of the plurality of second images, a detection reliability degree indicating a reliability degree of detection from one first image that is included in the plurality of first images and has been captured at substantially a same time as the second image,
wherein the mapper also maps the detection reliability degree onto the person included in the one second image, further based on the detection reliability degree estimated by the reliability degree estimator from the one second image.

9. The determination device according to claim 1,
wherein the distinctive region detector attempts to further detect a second distinctive region from each of a plurality of third images that include the person and have been captured at substantially a same time as the plurality of second images, the second distinctive region being a characteristic luminance distribution region,
when the distinctive region detector detects the second distinctive region from one or more third images included in the plurality of third images, the mapper further maps, for each of the one or more third images, the second distinctive region detected from the third image onto the person included in one second image that is included in the plurality of second images and has been captured at substantially a same time as the third image, based on the second distinctive region and the reference position calculated by the reference position calculator from the one second image, and
each of the plurality of third images is a sub-terahertz wave image.

10. The determination device according to claim 1,
wherein the sub-terahertz wave image is an image captured using electromagnetic waves of at least 0.05 THz and at most 2 THz.

11. A determination device comprising:
an estimator that estimates, from a second image that includes a person, a virtual sub-terahertz wave image which would be captured at substantially a same time as the second image if sub-terahertz waves were emitted to the person;
a distinctive region detector that detects a first distinctive region from a first image that includes the person and has been captured at substantially a same time as the second image, based on the virtual sub-terahertz wave image and the first image, the first distinctive region being a characteristic luminance distribution region;
a determiner that determines a possession of the person based on the first distinctive region; and
an outputter that outputs a determination result of the determiner,
wherein the first image is a sub-terahertz wave image, and
the second image is at least one of a visible light image, an infrared light image, or a distance image.

12. A determination method comprising:
detecting a first distinctive region from each of a plurality of first images that include a person and have been captured at mutually different time points, the first distinctive region being a characteristic luminance distribution region;
calculating a body region or a skeletal frame of the person from each of a plurality of second images that include the person and have been captured at substantially a same time as the plurality of first images, the body region or the skeletal frame being a reference position regarding movement of the person;
when the first distinctive region is detected from one or more first images included in the plurality of first images in the detecting, mapping, for each of the one or more first images, the first distinctive region detected from the first image onto the person included in one second image that is included in the plurality of second images and has been captured at substantially a same time as the first image, based on the first distinctive region and the reference position calculated from the one second image in the calculating;
determining a possession of the person based on a relative positional relationship between the person and the first distinctive region in a mapping result of the mapping; and
outputting a determination result of the determining,
wherein each of the plurality of first images is a sub-terahertz wave image, and
each of the plurality of second images is at least one of a visible light image, an infrared light image, or a distance image.

13. A determination method comprising:
estimating, from a second image that includes a person, a virtual sub-terahertz wave image which would be captured at substantially a same time as the second image if sub-terahertz waves were emitted to the person;
detecting a first distinctive region from a first image that includes the person and has been captured at substantially a same time as the second image, based on the virtual sub-terahertz wave image and the first image, the first distinctive region being a characteristic luminance distribution region;
determining a possession of the person based on the first distinctive region; and
outputting a determination result of the determining,
wherein the first image is a sub-terahertz wave image, and
the second image is at least one of a visible light image, an infrared light image, or a distance image.
